(19) United States
(12) Patent Application Publication
(10) Pub. No.: US 2019/0213472 A1
(43) Pub. Date: Jul. 11, 2019

(54) SPIKING NEURAL NETWORK-BASED NEUROMORPHIC SYSTEM

(71) Applicant: Electronics and Telecommunications Research Institute, Daejeon (KR)

(72) Inventors: Seong Mo PARK, Daejeon (KR); Sung Eun KIM, Daejeon (KR); Kwang IL OH, Daejeon (KR)

(73) Assignee: Electronics and Telecommunications Research Institute, Daejeon (KR)

(21) Appl. No.: 16/134,935

(22) Filed: Sep. 18, 2018

(30) Foreign Application Priority Data
Jan. 11, 2018 (KR) 10-2018-0004045

(51) Int. Cl. G06N 3/063; G06N 3/04; G06N 3/08

(52) U.S. Cl. CPC G06N 3/0635; G06N 3/088; G06N 3/049

(57) ABSTRACT

Provided is a neuromorphic system including a memory configured to store a plurality of weights, a potentiation unit configured to receive an input signal, generate a positive voltage on a basis of a first weight corresponding to the input signal among the plurality of weights, and accumulate the generated positive voltage to output a potentiation unit voltage, a depression unit configured to receive the input signal, generate a negative voltage on a basis of the first weight, and accumulate the generated negative voltage to output a depression unit voltage, and a firing unit configured to combine the potentiation unit voltage and the depression unit voltage to generate an internal voltage, and fire on a basis of a comparison result of the internal voltage and a threshold value.

### CROSS-REFERENCE TO RELATED APPLICATIONS

This U.S. non-provisional patent application claims priority under 35 U.S.C. § 119 of Korean Patent Application No. 10-2018-0004045, filed on Jan. 11, 2018, the entire contents of which are hereby incorporated by reference.

### BACKGROUND

The present disclosure herein relates to a neuromorphic system, and more particularly, to a spiking neural network-based neuromorphic system and an operation method thereof.

The brain includes hundreds of billions of nerve cells, namely neurons. A neuron may learn and memorize information through a synapse that transmits and receives a signal with thousands of other neurons. A neuromorphic system is a semiconductor circuit that emulates such a neuron or a synapse to process information.

The neuromorphic system may be used to realize an intelligent system capable of adapting for itself in an unspecific environment. Accordingly, the neuromorphic system is being investigated for effectively performing character recognition, voice recognition, risk recognition, or real-time high-speed signal processing, etc.

An algorithm for realizing the neuromorphic system may be divided into a supervised learning algorithm and an unsupervised learning algorithm. The supervised learning algorithm may be realized with simple hardware, but a lot of time and cost may be taken to secure a lot of pieces of learning data. The unsupervised learning algorithm may achieve high learning efficiency with a small amount of learning data, but take complex calculations and a lot of time.

### SUMMARY

The present disclosure provides a spiking neural network (SNN)-based neuromorphic system for realizing neuromorphic hardware according to an unsupervised learning algorithm.

An embodiment of the inventive concept provides a neuromorphic system including: a memory configured to store a plurality of weights; a potentiation unit configured to receive an input signal, generate a positive voltage on a basis of a first weight corresponding to the input signal among the plurality of weights, and accumulate the generated positive voltage to output a potentiation unit voltage; a depression unit configured to receive the input signal, generate a negative voltage on a basis of the first weight, and accumulate the generated negative voltage to output a depression unit voltage; and a firing unit configured to combine the potentiation unit voltage and the depression unit voltage to generate an internal voltage, and fire on a basis of a comparison result of the internal voltage and a threshold value.

In an embodiment, the firing unit may output an output signal according to the firing, and the output signal may be the internal voltage at a time of firing or a spike signal corresponding to the internal voltage.

In an embodiment, the neuromorphic system may further include a controller configured to receive the output signal and update the first weight stored in the memory on the basis of the received output signal.

In an embodiment, the neuromorphic system may further include a converter configured to receive input data and generate a spike signal of which an occurrence frequency is differed according to a magnitude or an intensity of the input data, and output the spike signal as the input signal.

In an embodiment, the potentiating unit may include: a potentiation calculation unit configured to generate the positive voltage on a basis of the input signal and the first weight; a counter configured to count an operation time of the potentiation unit to generate information on the operation time; and an accumulator configured to accumulate the positive voltage on the basis of the information on the operation time to output the potentiation unit voltage.

In an embodiment, the depression unit may include: a depression calculation unit configured to generate the negative voltage on a basis of the input signal and the first weight; a counter configured to count an operation of the depression unit to generate information on the operation time; and an accumulator configured to accumulate the negative voltage on the basis of the information on the operation time to output the depression unit voltage.

In an embodiment of the inventive concept, a neuromorphic system includes: a processor; and a memory coupled to the processor, wherein the memory stores instructions that, when executed by the processor, cause the processor to generate a potentiation unit voltage and a depression unit voltage on a basis of a weight corresponding to an input signal, when the input signal is received; combine the potentiation unit voltage and the depression unit voltage to generate an internal voltage; compare whether the internal voltage is greater than a threshold value; output an output signal, when the internal voltage is greater than the threshold value; and updating the weight on a basis of the output signal.

In an embodiment, the potentiation unit voltage may be positive and the depression unit voltage may be negative.

In an embodiment, each of the input signal and the output signal may be a spike signal.

In an embodiment, the weight is updated on a basis of a time when the output signal is generated.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates operations of neurons according to an embodiment of the inventive concept;

FIG. 2 illustrates an example of spike signals output from the neurons of FIG. 1;

FIGS. 3A to 3C illustrate examples of voltages of postsynaptic neurons of FIG. 1;

FIG. 4 illustrates a method for updating a weight between a presynaptic neuron and a postsynaptic neuron according to an embodiment of the inventive concept;

FIG. 5 is a block diagram showing a neuromorphic system according to an embodiment of the inventive concept;

FIG. 6 is a block diagram showing an additional embodiment of the neuromorphic system of FIG. 5;

FIG. 7 is a block diagram showing an example of a potentiation unit of FIG. 5;

FIG. 8 is a block diagram showing an additional example of the potentiation unit of FIG. 7;

FIG. 9 is a block diagram showing an example of a depression unit of FIG. 5;

FIG. 10 is a block diagram showing an additional example of the depression unit of FIG. 9; and

FIG. 11 is a flowchart showing an operation method of the neuromorphic system of FIG. 5.

### DETAILED DESCRIPTION

Hereinafter embodiments of the present inventive concept will be described in detail with reference to the accompanying drawings. In the following description, specific details such as detailed components and structures are provided to assist overall understanding of embodiments of the present disclosure. Therefore, various changes or modifications can be made by those of ordinary skill in the art in the specific details without departing from technical spirit and scope of the present disclosure. In addition, descriptions of well-known functions and constructions may be omitted for clarity and conciseness. Terms used herein are defined in consideration of functions of the present disclosure, and are not limited specific functions. The definitions of the terms can be determined based on details described in the specification.

Modules in the following drawing or description can be connected things other than elements shown in the drawing or described in the specification. Modules or elements can be respectively connected directly or indirectly to each other. Modules or elements can be respectively connected by communication or physical connection.

Elements described with reference to terms such as part, unit, module, or layer used in the description and functional blocks illustrated in the drawings can be implemented in a form of software, hardware, or a combination thereof. For example, the software can be machine code, firmware, embedded code, and application software. Also for example, the hardware can be electrical circuitry, electronic circuitry, processor, computer, integrated circuit, integrated circuit cores, a pressure sensor, an inertial sensor, a microelectromechanical system (MEMS), passive devices, or a combination thereof.

Unless defined otherwise, all the terms including technical or scientific terms used herein have the same meaning as those understood generally by a person having an ordinary skill in the art. The terms having the same meaning as those defined in generally used dictionaries shall be construed to have the meaning conforming to the contextual meaning of the related technologies, and shall not be construed as ideal or excessively formal meaning unless the terms are apparently defined in this application.

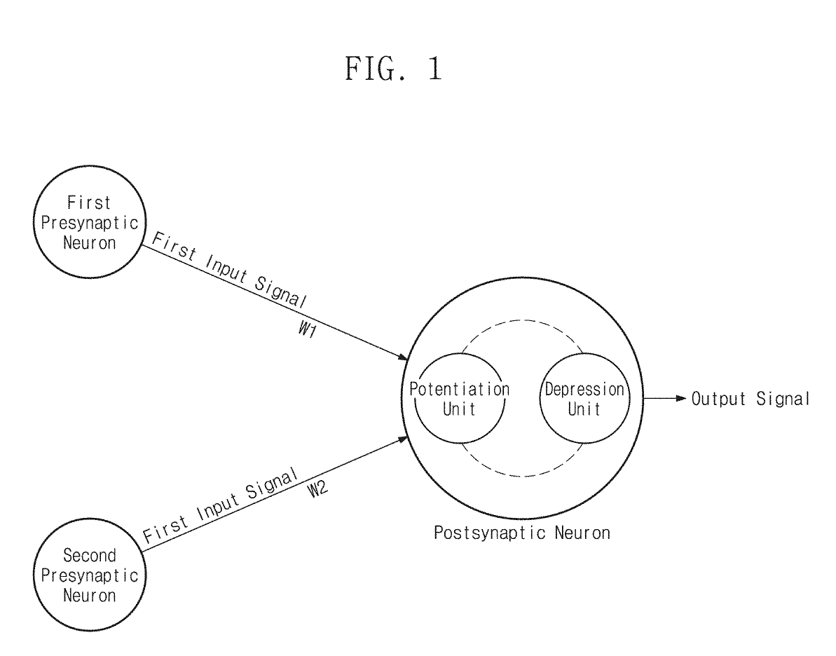

FIG. 1 illustrates operations of neurons according to an embodiment of the inventive concept. Referring to FIG. 1, a postsynaptic neuron may receive a first input signal and a second input signal respectively from a first presynaptic neuron and a second presynaptic neuron. The postsynaptic neuron may output an output signal on the basis of the first input signal and the second input signal.

The first input signal, the second input signal, and the output signal may be voltages generated in each neuron. Alternatively, the first input signal, the second input signal, and the output signal may be values corresponding voltages generated in each neuron.

The first presynaptic neuron and the postsynaptic neuron may be connected by a synapse having a first weight W1. The second presynaptic neuron and the postsynaptic neuron may be connected by a synapse having a second weight W2. Values of the first weight W1 and the second weight W2 may vary according to connection strengths between the presynaptic neurons and the post synaptic neuron. For example, when the connections strength between the first presynaptic neuron and the post synaptic neuron is strong, the first weight W1 may be larger. The connection strength between the second presynaptic neuron and the postsynaptic neuron is weak, the second weight W2 may be smaller.

The postsynaptic neuron may potentiate and depress the first input signal and the second input signal received from the first and second presynaptic neurons. The postsynaptic neuron may potentiate and depress the first input signal on the basis of the first weight W1. The postsynaptic neuron may potentiate and depress the second input signal on the basis of the second weight W2.

The postsynaptic neuron may include a potentiation unit and a depression unit. The potentiation unit may potentiate the first input signal on the basis of the first weight W1. When the first input signal is potentiated, an internal voltage (or a membrane potential) of the postsynaptic neuron may increase. In addition, the potentiation unit may potentiate the second input signal on the basis of the second weight W2. When the second input signal is potentiated, an internal voltage of the postsynaptic neuron may increase. In other words, the potentiation unit may potentiate the input signals received from the presynaptic neurons to increase the internal voltages.

The depression unit may depress the first input signal on the basis of the first weight W1. When the first input signal is depressed, the internal voltage of the postsynaptic neuron may decrease. In addition, the depression unit may depress the second input signal on the basis of the second weight W2. When the second input signal is depressed, the internal voltage of the postsynaptic neuron may decrease. In other words, the depression unit may depress the input signals received from the presynaptic neurons to decrease the internal voltages.

When the internal voltage of the postsynaptic neuron satisfies a predetermined condition, the postsynaptic neuron may output the output signal. For example, when the internal voltage is a threshold value or higher, the postsynaptic neuron may output the output signal. For example, the output signal output from the postsynaptic neuron may be a spike signal. The spike signal may be a signal output instantaneously at a specific time.

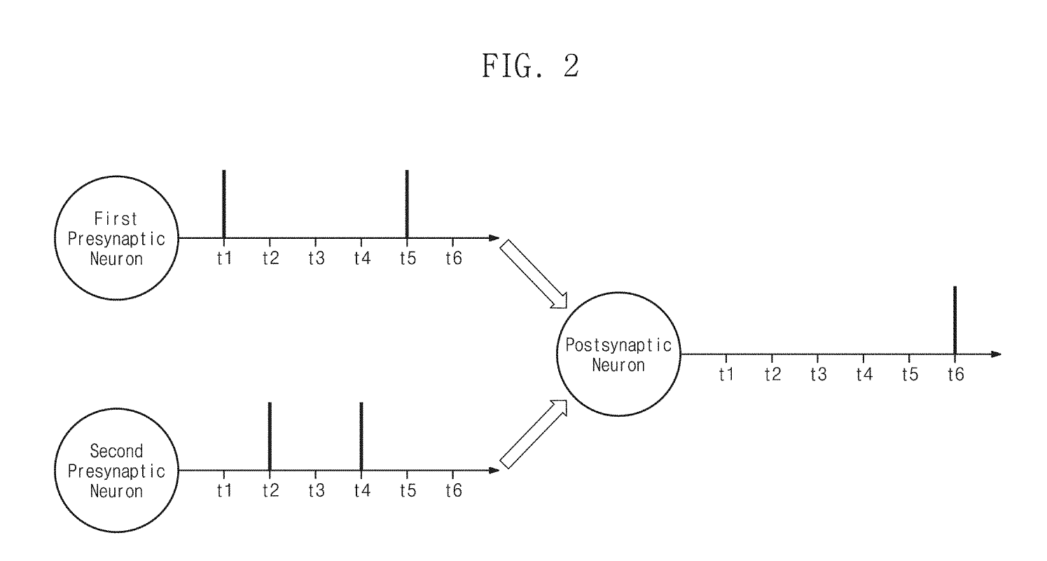

Similarly, the first input signal and the second input signal output from the first presynaptic neuron and the second presynaptic neuron may be spike signals. A detailed description about the spike signal will be provided later in relation to FIG. 2.

In this way, a neuron according to an embodiment of the inventive concept may receive or output a spike signal to deliver information. In other words, neurons according to an embodiment of the inventive concept may compose a spiking neural network (SNN).

As illustrated in FIG. 1, the postsynaptic neuron includes the potentiation unit and the depression unit, but is not limited thereto. Not only the postsynaptic neuron, but each of the first and second presynaptic neurons may also include a potentiation unit and a depression unit. The first and second presynaptic neurons may output signals according to input signals like the postsynaptic neuron.

As described above, a neuron according to an embodiment of the inventive concept may be modeled to include a potentiation unit and a depression unit. According to the inventive concept, each of the potentiation unit and the depression unit may be realized with hardware. In this case, not only a hardware structure for the spiking neural network becomes simple, but also the hardware structure may be realized which is similar to a biological model including a potentiation neuron and a depression neuron.

In FIG. 1, the postsynaptic neuron is illustrated to receive the first input signal and the second input signal from the first presynaptic neuron and the second presynaptic neuron, but the inventive concept is not limited thereto. The postsynaptic neuron may receive input signals from various presynaptic neurons, and potentiate and depress the input signals on the basis of weights respectively corresponding to the input signals. Hereinafter, for the convenience of explanation, the inventive concept will be described on the basis of an example in which the input signals are received from the two presynaptic neurons as illustrated in FIG. 1.

FIG. 2 illustrates an example of spike signals output from the neurons of FIG. 1. Referring to FIGS. 1 and 2, the first presynaptic neuron, the second synaptic neuron, and the postsynaptic neuron may respectively output spike signals. When spike signals from the first presynaptic neuron and the second presynaptic neuron are input to the postsynaptic neuron, the post synaptic neuron may output a spike signal on the basis of the input spike signals.

As illustrated in FIG. 2, the first presynaptic neuron may output spike signals at a first time t1 and a fifth time t5. The second presynaptic neuron may output spike signals at a second time t2 and a fourth time t4. The postsynaptic neuron may change an internal voltage on the basis of the spike signal input each time. For example, when each spike signal is input, the postsynaptic neuron may change the internal voltage by potentiating or depressing a spike voltage on the basis of the corresponding weight. When the internal voltage is a threshold value or higher, the postsynaptic neuron may generate and output the spike signal.

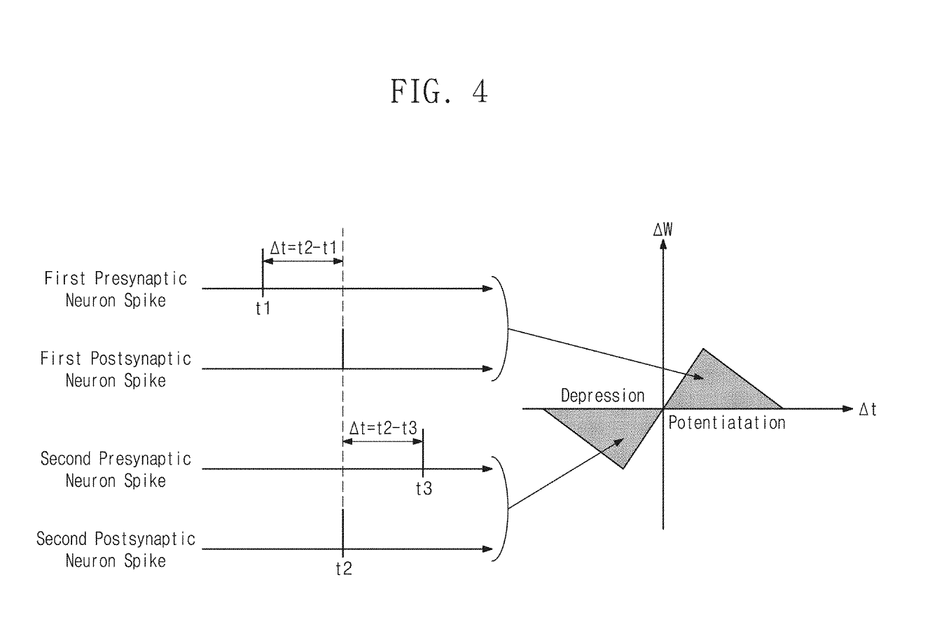

When the internal voltage of the postsynaptic neuron becomes the threshold value or higher by the spike signal at the fifth time t5, the postsynaptic neuron may output a spike signal at a time t6. The first weight W1 and the second weight W2 may be updated on the basis of the spike signal output from the postsynaptic neuron. For example, the weight according to an embodiment of the invention may be updated using a spike timing dependent plasticity (STDP). A detailed description thereabout will be provided in relation to FIG. 4.

When a spike signal is output at the sixth time t6, the internal voltage of the postsynaptic neuron may be initialized. After the initialization, the postsynaptic neuron may enter a refractory period. In the refractory period, even when spike signals are delivered by the first and second presynaptic neurons, the internal voltage of the postsynaptic neuron may not change. After the refractory period, when spike signals are delivered by the first and second presynaptic neurons, the postsynaptic neuron may change the internal voltage according to the input spike signals. Accordingly, the postsynaptic neuron may output again a spike signal after the sixth time t6.

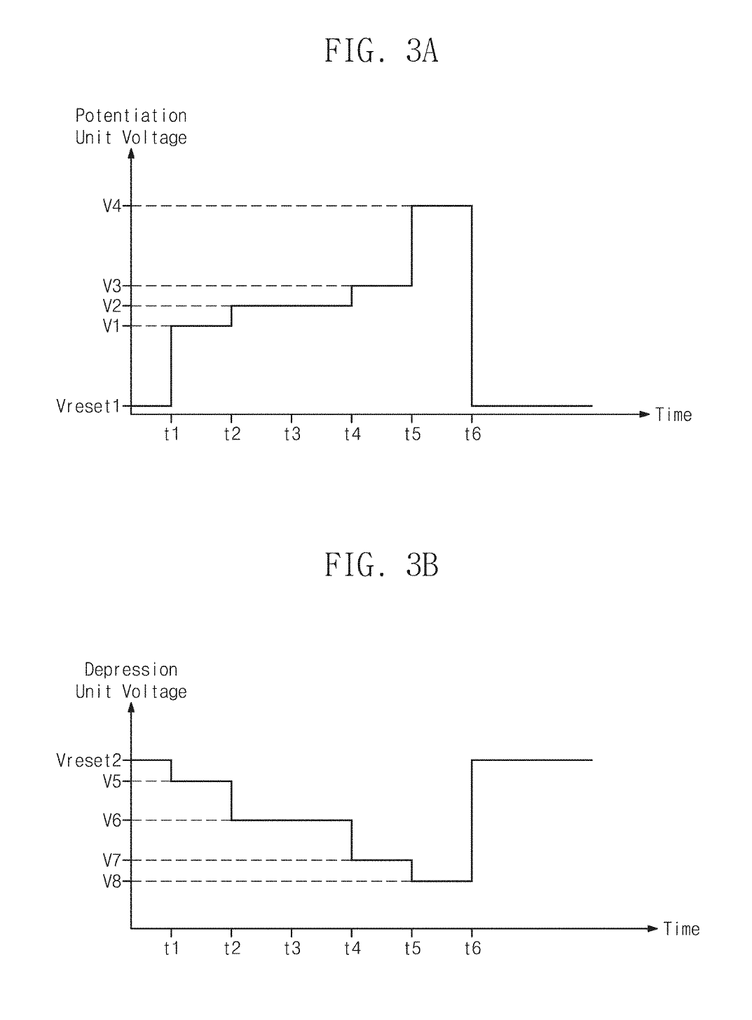

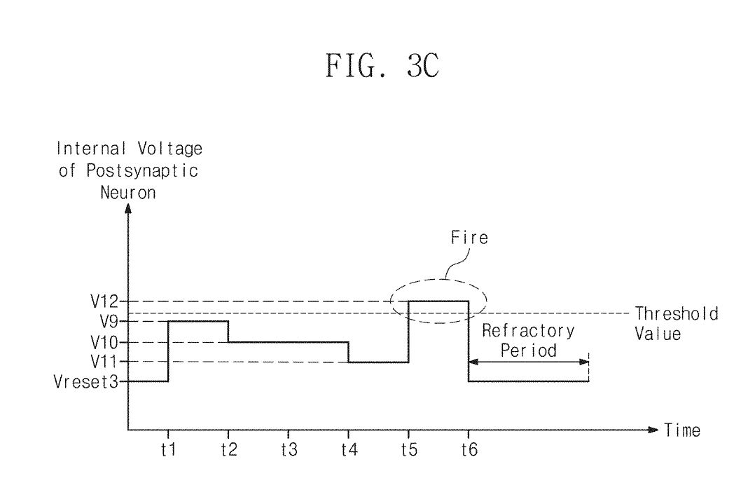

FIGS. 3A to 3C illustrate examples of voltages of postsynaptic neurons of FIG. 1. In detail, FIG. 3A illustrates an example of a voltage change in the potentiation unit, and FIG. 3B illustrates an example of a voltage change in the depression unit. FIG. 3C illustrates an internal voltage change in the postsynaptic neuron. Referring to FIGS. 1 to 3C, when the spike signals are input from the first and second presynaptic neurons, the potentiation unit may generate a potentiation unit voltage on the basis of the first weight W1 and the second weight W2, and the depression unit may generate a depression unit voltage on the basis of the first weight W1 and the second weight W2.

As illustrated in FIG. 3A, in an initialized state, the potentiation unit voltage may maintain a first reset voltage Vreset1. When the spike signal is input from the first presynaptic neuron at the first time t1, the potentiation unit may generate a voltage on the basis of the first weight W1. The magnitude of the voltage generated by the potentiation unit may be positive. By the generated voltage, the potentiation unit voltage may be increased to a first voltage V1. When the spike signal is input from the second presynaptic neuron at the second time t2, the potentiation unit may generate a voltage on the basis of the second weight W2. By the generated voltage, the potentiation unit voltage may be increased to a second voltage V2. Similarly, the potentiation voltage may be increased to a third voltage V3 by the spike signal input at the fourth time t4, and may be increased to a fourth voltage V4 by the spike signal input at the fifth time t5.

In this way, the potentiation unit may generate a positive voltage on the basis of the input spike signal, and accumulate the generated voltage to increase the magnitude of the potentiation unit voltage.

For example, when spike signals are potentiated on the basis of an identical weight, the potentiation unit may generate voltages of the same magnitude. The potentiation unit may potentiate the spike signals input at the first time t1 and the fifth time t5 on the basis of the first weight W1 to increase the potentiation unit voltages by the same magnitude. Accordingly, the potentiation unit may increase the potentiation unit voltage to the first voltage V1 at the first time t1, and to the fourth voltage V4 at the fifth time t5. Similarly, the potentiation unit may increase the potentiation unit voltages by the same magnitude by potentiating the input spike signals input at the second time t2 and at the fourth time t4 on the basis of the second weight W2. In other words, the magnitude of the generated voltage may vary according to the weight between the presynaptic neuron and the postsynaptic neuron.

As illustrated in FIG. 3B, in the initialized state, the depression voltage may maintain a second reset voltage Vreset2. When the spike signal is input from the first presynaptic neuron at the first time t1, the depression unit may generate a voltage on the basis of the first weight W1. The magnitude of the voltage generated by the depression unit may be negative. By the generated voltage, the depression unit voltage may be decreased to a fifth voltage V5. When the spike signal is input from the second presynaptic neuron at the second time t2, the depression unit may generate a voltage on the basis of the second weight W2. By the generated voltage, the depression unit voltage may be decreased to the sixth voltage V6. Similarly, the depression voltage may be decreased to a seventh voltage V7 by the spike signal input at the fourth time t4, and may be decreased to an eighth voltage V8 by the spike signal input at the fifth time t5.

In this way, the depression unit may generate a negative voltage on the basis of the input spike signal, and accumulate the generated voltage to decrease the magnitude of the depression unit voltage.

For example, when spike signals are depressed on the basis of an identical weight, the depression unit may generate voltages of the same magnitude. The depression unit may depress the spike signals input at the first time t1 and the fifth time t5 on the basis of the first weight W1 to decrease the depression unit voltages by the same magnitude. Accordingly, the depression unit may decrease the depression unit voltage to a fifth voltage V5 at the first time t1, and to an eighth voltage V8 at the fifth time t5. Similarly, the depression unit may decrease the depression unit voltages by the same magnitude by depressing the spike signals input at the second time t2 and the fourth time t4 on the basis of the second weight W2.

As illustrated in FIG. 3C, in the initialized state, the internal voltage of the post synaptic neuron may maintain a third reset voltage Vreset3. The internal voltage of the postsynaptic neuron may be a sum of the potentiation unit voltage and the depression unit voltage. The internal voltage at the first time t1 may have a value obtained by summing the potentiation unit voltage and the depression unit voltage at the first time t1, and the internal voltage at the second time t2 may have a value obtained by summing the potentiation unit voltage and the depression unit voltage at the second time t2. Accordingly, the internal voltages at the first time t1, the second time t2, the fourth time t4, and the fifth time t5 may be respectively, a ninth voltage V9, a tenth voltage V10, an eleventh voltage V11, and a twelfth voltage V12.

Since, at the first time t1 and the fifth time t5, the magnitude of the increase in the potentiation unit voltage is larger than the magnitude of the decrease in the depression unit voltage, the internal voltage may increase. Since, at the second time t2 and the fourth time t4, the magnitude of the increase in the potentiation unit voltage is larger than the magnitude of the decrease in the depression unit voltage, the internal voltage may decrease.

At the fifth time t5, the magnitude of the internal voltage of the postsynaptic neuron may be a threshold value or higher. Accordingly, the postsynaptic neuron may fire. When firing, the postsynaptic neuron may output a spike signal. As illustrated in FIG. 2, the postsynaptic neuron at the sixth time t6 may output the spike signal. For convenience of explanation, the postsynaptic neuron is described to fire at the sixth time t6, the inventive concept is not limited thereto. As illustrated in FIG. 3C, the postsynaptic neuron may fire between the fifth time t5 and the sixth time t6.

After firing, the postsynaptic neuron may be initialized. When the postsynaptic neuron is initialized, the internal voltage may be changed again to the third reset voltage Vreset3. The potentiation unit and the depression unit included in the postsynaptic neuron may also be initialized. Accordingly, the potentiation unit voltage may be changed again to the first reset voltage Vreset1, and the depression unit voltage may be changed again to the second reset voltage Vreset2.

After the initialization, the postsynaptic neuron may enter a refractory period for a constant time. When the postsynaptic neuron enters the refractory period, the internal voltage of the postsynaptic neuron may not be changed even when the spike signal is input. The potentiation unit voltage and the depression unit voltage may not be also changed even when the spike signal is input.

As illustrated in FIGS. 3A and 3B, when the weights corresponding to the input spike signals are identical, the magnitudes of positive voltages generated by the potentiation unit may be the same, or the magnitudes of negative voltages generated by the depression unit may be the same. However, the inventive concept is not limited thereto. In other words, even though the weights corresponding to the input spike signals are identical, the magnitudes of the positive voltages generated by the potentiation unit may be different, and the magnitudes of the negative voltages generated by the depression unit may be different. For example, when the magnitudes of the spike signals are different, the magnitude of the voltage generated at the first time t1 may be different from that generated at the fifth time t5. Accordingly, the magnitude of the voltage increased at the first time t1 may become different from that increased at the fifth time t5.

FIG. 4 illustrates a method for updating a weight between a presynaptic neuron and a postsynaptic neuron according to an embodiment of the inventive concept. A neuron according to an embodiment of the inventive concept may be updated using an STDP. Hereinafter, the concept of the STDP will be described in relation to FIG. 4.

A weight change amount ΔW may vary on the basis of a time at which a spike signal of the postsynaptic neuron is output and a time at which a spike signal of the presynaptic neuron is output. As illustrated in FIG. 4, the first presynaptic neuron may output a spike signal at a first time t1, and a first postsynaptic neuron may output a spike signal at a second time t2 (i.e., the first presynaptic neuron may output the spike signal prior to the first postsynaptic neuron). In this case, a difference between the second time t2 and the first time t1 may be positive and a weight between the first presynaptic neuron and the first postsynaptic neuron may be updated so as to be potentiated. In other words, the change amount ΔW of the weight may have a positive value.

As illustrated in FIG. 4, a second postsynaptic neuron may output a spike signal at the second time t2, and the second presynaptic neuron may output a spike signal at a third time t3 (i.e., the second presynaptic neuron may output the spike signal posterior to the second postsynaptic neuron). In this case, a difference between the second time t2 and the third time t3 may be negative, a weight between the second presynaptic neuron and the second postsynaptic neuron may be updated so as to be depressed. In other words, the change amount ΔW of the weight may have a negative value.

The change amount ΔW of the postsynaptic neuron may vary according to a time difference Δt between a time at which the postsynaptic neuron outputs a spike signal and a time at which the presynaptic neuron output a spike signal. For example, as an absolute value of the time difference Δt is smaller, the change amount ΔW of the weight may be larger. For example, when the postsynaptic neuron outputs a spike signal after the presynaptic neuron outputs a spike signal, the weight may increase larger, as the time difference Δt is smaller.

As described above, the weight between the presynaptic neuron and postsynaptic neuron according to an embodiment of the inventive concept may be updated using the STDP.

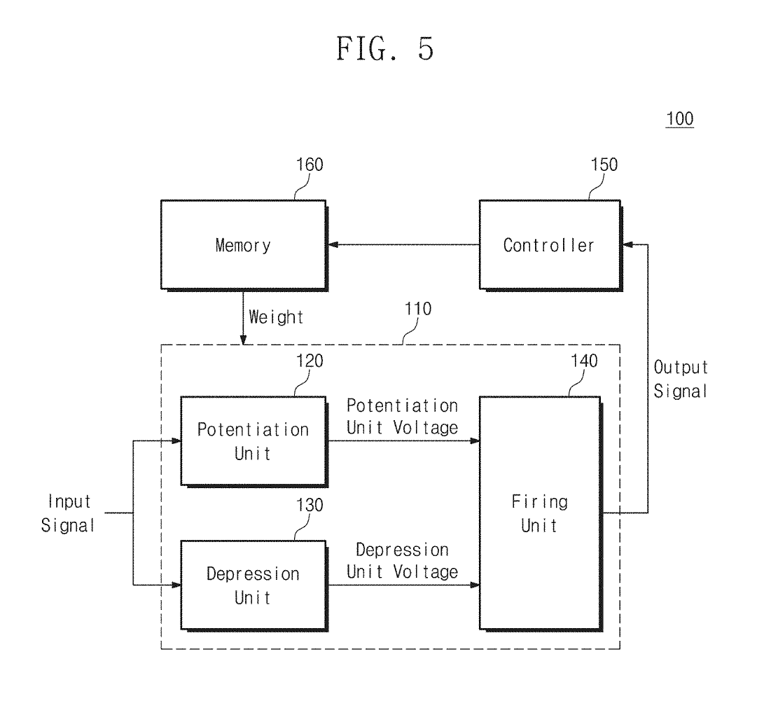

FIG. 5 is a block diagram showing a neuromorphic system according to an embodiment of the inventive concept. In relation to FIG. 5, the neuromorphic system 100 may include a neuron unit 110, a controller 150, and a memory 160, and the neuron unit 110 may include a potentiation unit 110, a depression unit 130, and a firing unit 140. The neuromorphic system 100 may operate on the basis of an operation manner of the postsynaptic neuron described in relation to FIGS. 1 to 4.

The neuron unit 110 may receive an input signal, and output an output signal on the basis of a weight corresponding to the input signal. When the input signal is received, the neuron unit 110 may read a corresponding weight from the memory 160. For example, the input signal may a spike signal or a value corresponding to the spike signal. The memory 160 may store a plurality of weights that indicate connection strengths of a plurality of neurons on a spiking neural network including the plurality of neurons. The controller 150 may include information on a topology of the spiking neural network. The controller 150 may control the memory 160 so that a weight corresponding to an input signal is provided to the neuron unit 110 on the basis of the information on the topology.

For example, referring to FIG. 1, when the first input signal is input to the neuron unit 110, the controller 150 may control the memory 160 so that the first weight W1 corresponding to the first input signal is provided to the neuron unit 110. Accordingly, when the first input signal is received, the first weight W1 is provided from the memory 160 to the neuron unit 110, and the neuron unit 110 may potentiate and depress the first input signal.

The potentiation unit 120 may receive an input signal and potentiate the received input signal on the basis of a corresponding weight. The potentiation unit 120 may potentiate the received input signal to output a potentiation unit voltage having a positive value. As the input signal is received, the potentiation unit 120 may increase the potentiation unit voltage. In other words, the magnitude of the potentiation unit voltage may be accumulated and increased according to the reception of the input signal. For example, as illustrated in FIG. 3A, the potentiating unit 120 may increase the magnitude of the potentiation unit voltage on the basis of the corresponding weight, as the input signals are received at the first time t1 to the fifth time t5.

The depression unit 130 may receive the input signal and depress the received input signal on the basis of a corresponding weight. The depression unit 130 may depress the received input signal to output a depression unit voltage having a negative voltage. As the input signal received, the depression unit 130 may decrease the depression voltage. In other words, the magnitude of the depression unit voltage may be accumulated and decreased as the input signal is received. For example, as illustrated in FIG. 3B, the depression unit 130 may decrease the magnitude of the depression unit voltage on the basis of a corresponding weight, as the input signals are received at the first time t1 to the fifth time t5.

The firing unit 140 may receive the potentiation unit voltage and the depression unit voltage, and combine the potentiation unit voltage and the depression unit voltage. The firing unit 140 may combine the potentiation unit voltage and the depression unit voltage to generate an internal voltage. The internal voltage may correspond to the internal voltage of the postsynaptic neuron of FIG. 3C.

For example, the firing unit 140 may include an adder (not shown). The adder may add the potentiation unit and the depression unit voltage to generate the internal voltage.

The firing unit 140 may compare the internal voltage with a threshold value and fire on the basis of the comparison result. When the internal voltage is a threshold value or greater, the firing unit 140 may fire to output an output signal. For example, the output signal may be the internal voltage at the time of firing or a spike signal corresponding to the internal voltage. The firing unit 140 may deliver the output signal to the controller 150.

For example, the firing unit 140 may include a comparator (not shown). The comparator may compare the internal voltage with a pre-stored threshold value, and output an output signal on the basis of the comparison result.

The controller 150 may update the weight stored in the memory 160 on the basis of a received output signal. The controller 150 may change a weight provided to the neuron unit 110 to another weight. For example, the controller 150 may update the weight to a value corresponding to the output signal. Alternatively, the controller 150 may update the weight using the STDP described in relation to FIG. 4.

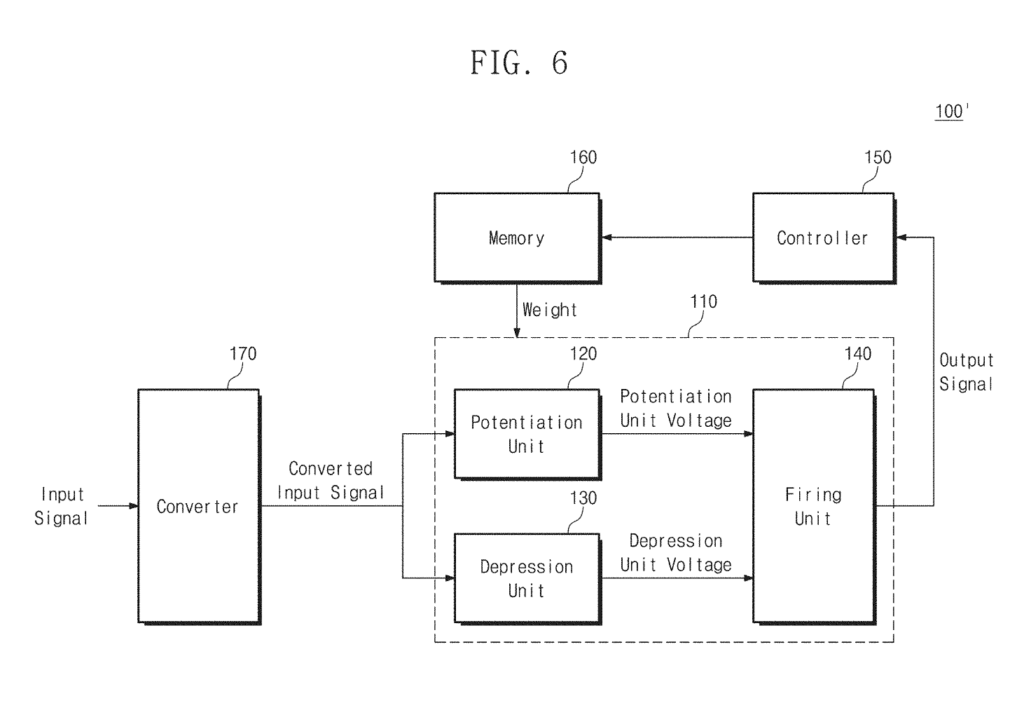

FIG. 6 is a block diagram showing an additional embodiment of the neuromorphic system of FIG. 5. In relation to FIG. 6, the neuromorphic system 100′ may include a neuron unit 110, a controller 150, a memory 160 and a converter 170, and the neuron unit 110 may include a potentiation unit 120, a depression unit 130 and a firing unit 140. Operations of the neuron unit 110, the controller 150 and the memory 160 of FIG. 6 are similar to those of the neuron unit 110, the controller 150 and the memory 160 of FIG. 5, and thus detailed descriptions thereabout will be omitted.

The converter 170 may receive an input signal and convert the received input signal to output the converted input signal. When the input signal is received, the converter 170 may convert the input signal to a type capable of being processed by the neuron unit 110. For example, when pixel data of an image is received as an input signal, the converter 170 may convert the input signal, which indicates a pixel value of the image, to a spike signal as illustrated in FIG. 2. The converter 170 may generate the spike signal of which a generation frequency varies according to the intensity of the pixel value of the image. The converter 170 may provide the converted input signal to the potentiation unit 120 and the depression unit 130 of the neuron unit 110.

The neuron unit 110 may potentiate and depress the converted input signal provided from the converter 170. The neuron unit 110 may generate a potentiation unit voltage and a depression unit voltage through the potentiation unit 120 and the depression unit 130. When a sum of the potentiation unit voltage and the depression unit voltage is a threshold value or greater, the neuron unit 110 may fire to output an output signal.

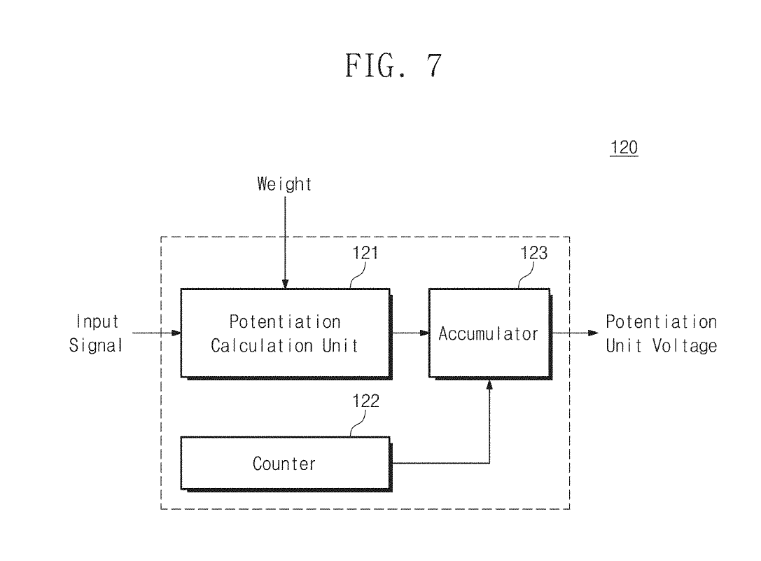

FIG. 7 is a block diagram illustrating an example of the potentiation unit of FIG. 5. Referring to FIGS. 5 and 7, the potentiation unit 120 may include a potentiation calculation unit 121, a counter 122 and an accumulator 123. The potentiation calculation unit 121 may receive an input signal and a corresponding weight.

The potentiation calculation unit 121 may generate a positive voltage on the basis of the input signal and the weight. The voltage generated from the potentiation calculation unit 121 may be provided to the accumulator 123.

The counter 122 may count an operation time of the potentiation unit 120. The counter 122 may count the operation time on the basis of a separate clock signal. The counter 122 may provide information on the operation time to the accumulator 123.

The accumulator 123 may receive the voltage from the potentiation calculation unit 121, and receive the information on the operation time from the counter 122. The accumulator 123 may accumulate the received voltage on the basis of the information on the operation time. The accumulator 123 may output the accumulated voltage as the potentiation unit voltage. For example, as illustrated in FIG. 3A, the accumulator 123 may receive information on the first time t1 to the fifth time t5 from the counter 122. The accumulator 123 may output the first voltage V1 as the potentiation unit voltage on the basis of a voltage provided from the potentiation calculation unit 121 at the first time t1. The accumulator 123 may output the second voltage V2 as the potentiation unit voltage on the basis of a voltage provided from the potentiation calculation unit 121 at the fifth time t5. In such a manner, the accumulator 123 may output the fourth voltage V4 as the potentiation voltage on the basis of the voltage provided from the potentiation calculation unit 121 at the fifth time t5.

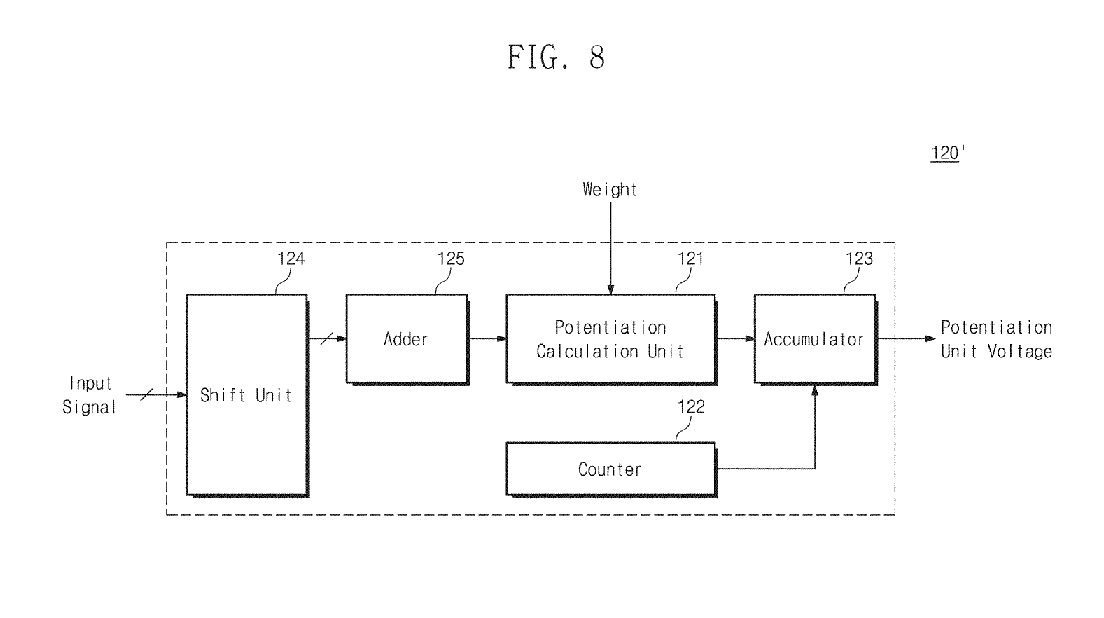

FIG. 8 is a block diagram showing an additional example of the potentiation of FIG. 7. Referring to FIG. 8, a potentiation unit 120′ may include a potentiation calculation unit 121, a counter 122, an accumulator 123, a shift unit 124, and an adder 125. Operations of the potentiation calculation unit 121, the counter 122, and the accumulator 123 of FIG. 8 are similar to those of the potentiation calculation unit 121, the counter 122, and the accumulator 123, and thus detailed descriptions thereabout will be omitted.

As illustrated in FIG. 8, the potentiation unit 120′ may receive a plurality of input signals. For example, the input signal of FIG. 7 may be one input signal corresponding to an image pixel value, and the plurality of input signals of FIG. 8 may correspond to a plurality of divided image pixel values.

The shift unit 124 may shift a plurality of received input signals. The shift unit 124 may receive the plurality of input signals and shift each of the plurality of input signals to decrease the magnitude of the input signal. The plurality of input signals of which magnitudes are decreased by the shift unit 124 may be provided to the adder 125.

The adder 125 may perform addition on the plurality of input signals delivered from the shift unit 124. The adder 125 may provide an input signal generated according to the addition result to the potentiation calculation unit 121. Accordingly, the input signal provided to the potentiation calculation unit 121 may be one input signal like the input signal of FIG. 7.

The potentiation calculation unit 121 may generate a positive voltage on the basis of the received input signal and the weight, and deliver the generated voltage to the accumulator 123. The accumulator 123 may accumulate the voltage on the basis of the operation time information provided from the counter 122 and output the accumulated voltage as the potentiation unit voltage.

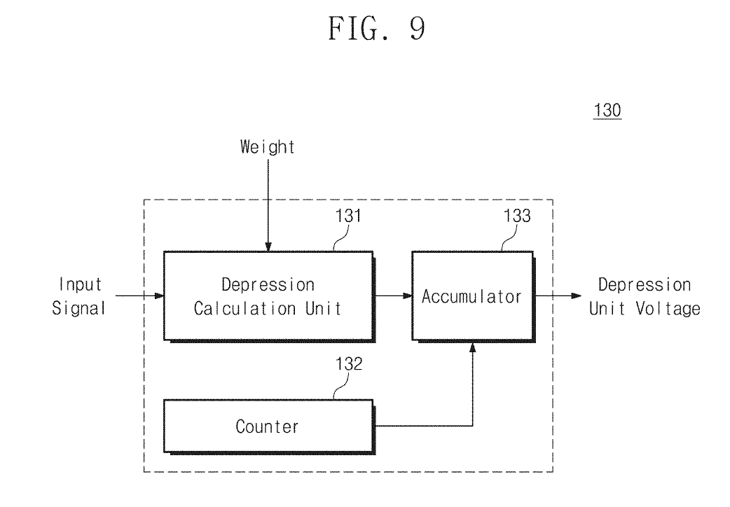

FIG. 9 is a block diagram showing an example of the depression unit of FIG. 5. Referring to FIGS. 5 and 9, the depression unit 130 may include a depression calculation unit 131, a counter 132 and an accumulator 133. The depression calculation unit 131 may receive an input signal and a corresponding weight.

The depression calculation unit 131 may generate a negative voltage on the basis of the input signal and the weight. The voltage generated in the depression calculation unit 131 may be provided to the accumulator 133.

The counter 132 may count an operation time of the depression unit 130. For example, the counter 132 may count the operation time on the basis of a separate clock signal. The counter 132 may provide information on the operation time to the accumulator 133.

The accumulator may receive the voltage from the depression calculation unit 131 and receive the information on the operation time from the counter 132. The accumulator 133 may accumulate the received voltage on the basis of the information on the operation time. The accumulator 133 may output the accumulated voltage as the depression unit voltage. For example, as illustrated in FIG. 3B, the accumulator 133 may receive information on the first time t1 to the fifth time t5 from the counter 132. The accumulator 133 may output the fifth voltage V5 as the depression unit voltage on the basis of the voltage provided from the depression calculation unit 131 at the first time t1. The accumulator 133 may output the sixth voltage v6 on the basis of the voltage provided from the depression calculation unit 131 at the second time t2. In this way, the accumulator 133 may output the eighth voltage V8 as the depression unit voltage on the basis of the voltage provided from the depression calculation unit 131 at the fifth time t5.

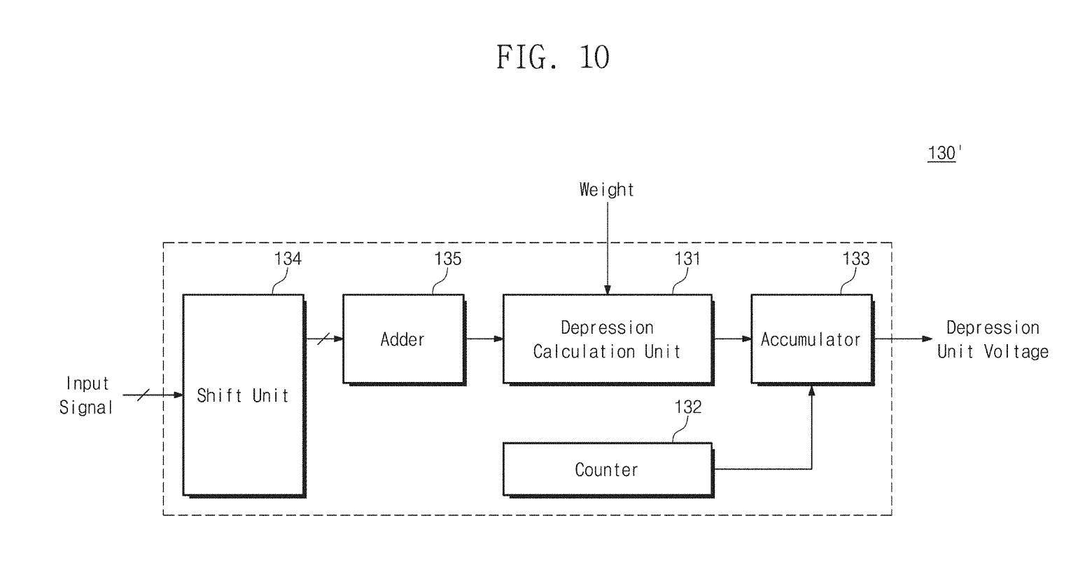

FIG. 10 is a block diagram showing an additional example of the depression unit of FIG. 9. Referring to FIG. 10, a depression unit 130′ may include a depression calculation unit 131, a counter 132, an accumulator 133, a shift unit 134, and an adder 135. Operations of the depression calculation unit 131, the counter 132 and the accumulator 133 are similar to those of the depression calculation unit 131, the counter 132 and the accumulator 133, and thus detailed descriptions thereabout will be omitted. In addition, operations of the shift unit 134 and the adder 135 of FIG. 10 are similar to those of the shift unit 124 and the adder 125 of FIG. 8, and thus detailed descriptions thereabout will be omitted.

The depression unit 130′ may receive a plurality of input signals, and generate one input signal through the shift unit 134 and the adder 135. The depression calculation unit 131 may generate a negative voltage on the basis of the received input signal and the weight, and deliver the generated voltage to the accumulator 133. The accumulator 133 may accumulate the voltage on the basis of the operation time information provided from the counter 132, and output the accumulated voltage as the depression unit voltage.

As described above, the neuromorphic system 100 according to an embodiment of the inventive concept may be implemented with spiking neural network (SNN)-based hardware. The neuron unit 110 of the neuromorphic system 100 may include the potentiation unit 120 and the depression unit 130 similar to a biological model including a potentiation neuron and a depression neuron. The potentiation unit 120 and the depression unit 130 may substantially simultaneously generate the potentiation unit voltage and the depression unit voltage on the basis of input signals. The neuron unit 110 may fire on the basis of the generated potentiation unit voltage and the depression unit voltage. The potentiation unit 120 and the depression unit 130 may be implemented with separate hardware and substantially simultaneously operate, and thus the calculation speed of the neuron unit 110 may be accelerated.

Accordingly, the neuromorphic system 100 according to an embodiment of the inventive concept may not only simplify a hardware structure for the spiking neural network, but also substantially simultaneously perform the potentiation and depression operations on the basis of input signals, and thus accelerate the operation speed.

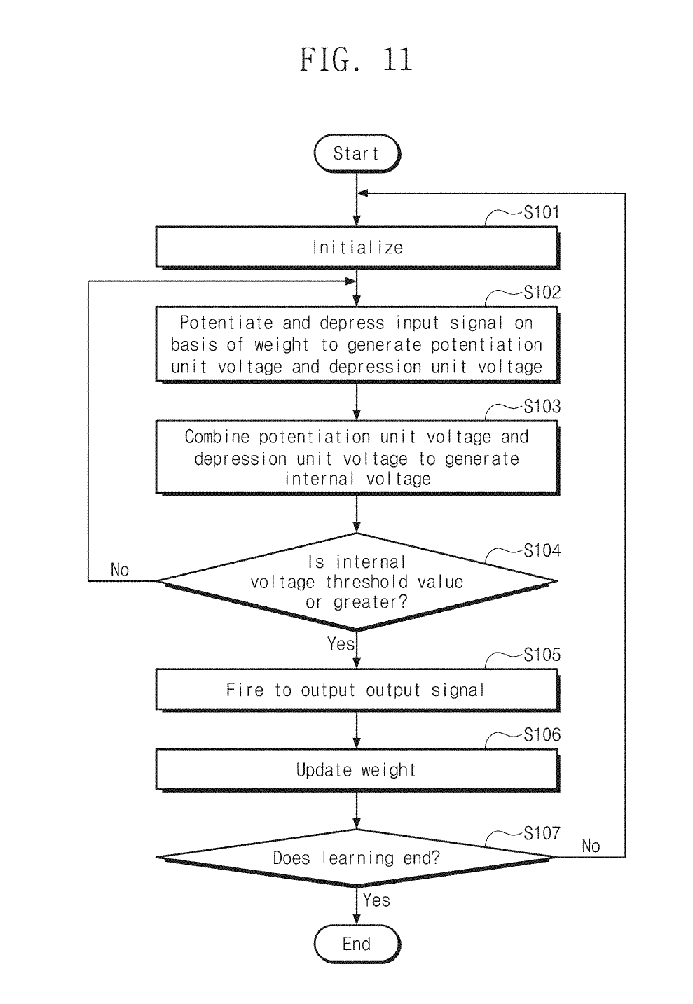

FIG. 11 is a flowchart showing an operation method of the neuromorphic system of FIG. 5. Referring to FIGS. 5 and 11, in operation S101, the neuromorphic system 100 may be initialized. When the neuromorphic system 100 is initialized, all voltages of the neuron unit 110 may be initialized. In other words, as illustrated in FIGS. 3A to 3C, the potentiation unit voltage, the depression unit voltage and the internal voltage of the neuron unit may respectively be changed to a first reset voltage, a second reset voltage and a third reset voltage.

In operation S102, the neuromorphic system 100 may potentiate and depress the received input signal on the basis of a weight to generate the potentiation unit voltage and the depression unit voltage. The neuromorphic system 100 may potentiate and depress the input signal using the weight corresponding to the received input signal among pre-stored weights. The neuromorphic system 100 may generate a positive potentiation unit voltage and a negative depression unit voltage on the basis of the input signal and the weight.

In operation S103, the neuromorphic system 100 may combine the potentiation unit voltage and the depression unit voltage to generate the internal voltage. The generated internal voltage may be a voltage accumulated according to the input signal.

In operation S104, the neuromorphic system 100 may determine whether the internal voltage is not smaller than a threshold value. In operation S105, when the internal voltage is the threshold or greater, the neuromorphic system 100 may fire and output an output signal. For example, the output signal may be the internal voltage at the time of firing, or a spike signal corresponding to the internal voltage. When the internal voltage is smaller than the threshold value, the neuromorphic system 100 may repeat operations S102 to S104.

In operation S106, the neuromorphic system 100 may update the weight on the basis of the output signal. The neuromorphic system 100 may update the weight to have a weight value corresponding to the output signal. Alternatively, the neuromorphic system 100 may update the weight on the basis of a generation time of the output signal.

In operation S107, the neuromorphic system 100 may determine whether learning ends. When the learning ends, the neuromorphic system 100 may end an operation for updating the weight. When the learning does not end, the neuromorphic system 100 may repeat operations S101 to S107. In operation S101, when the neuromorphic system 100 is initialized, the potentiation unit voltage, the depression unit voltage and the internal voltage generated in operations S102 and S103 may all be reset. Accordingly, as illustrated in FIGS. 3A to 3C, the potentiation unit voltage, the depression unit voltage and the internal voltage may be changed to the reset voltages.

For example, operations of FIG. 11 are performed by a neuromorphic system according to embodiments of the present disclosure. The neuromorphic system comprises a processor(not shown) and a memory(not shown) coupled to the processor, wherein the memory stores instructions that, when executed by the processor, cause the processor to perform the operations of FIG. 11.

A neuromorphic system according to embodiments of the present disclosure may simplify a hardware structure of a spiking neural network to reduce a cost for hardware realization.

In addition, a neuromorphic system according to embodiments of the present disclosure may perform potentiation and depression operations for an input value.

The above-described is detailed embodiments for practicing the present inventive concept. The present disclosure includes not only the above-described embodiments but also simply changed or easily modified embodiments. In addition, the present inventive concept also include techniques easily modified and practiced using the embodiments of the present disclosure. Therefore, the scope of the present disclosure is not limited to the described embodiments but is defined by the claims and their equivalents.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A neuromorphic system comprising:
a memory configured to store a plurality of weights;
a potentiation unit configured to receive an input signal, generate a positive voltage on a basis of a first weight corresponding to the input signal among the plurality of weights, and accumulate the generated positive voltage to output a potentiation unit voltage;
a depression unit configured to receive the input signal, generate a negative voltage on a basis of the first weight, and accumulate the generated negative voltage to output a depression unit voltage; and
a firing unit configured to combine the potentiation unit voltage and the depression unit voltage to generate an internal voltage, and fire on a basis of a comparison result of the internal voltage and a threshold value.

2. The neuromorphic system of claim 1, wherein the firing unit outputs an output signal according to the firing, and the output signal is the internal voltage at a time of firing or a spike signal corresponding to the internal voltage.

3. The neuromorphic system of claim 2, further comprising:
a controller configured to receive the output signal and update the first weight stored in the memory on the basis of the received output signal.

4. The neuromorphic system of claim 1, further comprising:
a converter configured to receive input data and generate a spike signal of which an occurrence frequency is differed according to a magnitude or an intensity of the input data, and output the spike signal as the input signal.

5. The neuromorphic system of claim 1, wherein the potentiating unit comprises:
a potentiation calculation unit configured to generate the positive voltage on a basis of the input signal and the first weight;
a counter configured to count an operation time of the potentiation unit to generate information on the operation time; and
an accumulator configured to accumulate the positive voltage on the basis of the information on the operation time to output the potentiation unit voltage.

6. The neuromorphic system of claim 1, wherein the depression unit comprises:
a depression calculation unit configured to generate the negative voltage on a basis of the input signal and the first weight;
a counter configured to count an operation of the depression unit to generate information on the operation time; and
an accumulator configured to accumulate the negative voltage on the basis of the information on the operation time to output the depression unit voltage.

7. A neuromorphic system comprising:
a processor; and
a memory coupled to the processor, wherein the memory stores instructions that, when executed by the processor, cause the processor to:
generate a potentiation unit voltage and a depression unit voltage on a basis of a weight corresponding to an input signal, when the input signal is received;
combine the potentiation unit voltage and the depression unit voltage to generate an internal voltage;
compare whether the internal voltage is greater than a threshold value;
output an output signal, when the internal voltage is greater than the threshold value; and
update the weight on a basis of the output signal.

8. The neuromorphic system of claim 7, wherein the potentiation unit voltage is positive and the depression unit voltage is negative.

9. The neuromorphic system of claim 7, wherein each of the input signal and the output signal is a spike signal.

10. The neuromorphic system of claim 7, wherein the weight is updated on a basis of a time when the output signal is generated.
